(19) United States
(12) Patent Application Publication
(10) Pub. No.: US 2025/0005593 A1
(43) Pub. Date: Jan. 2, 2025

(54) METHODS, SYSTEMS AND COMPUTER READABLE MEDIA FOR BULK DATA VALIDATION FOR DRAFT-BASED SAP FIORI APPLICATIONS

(71) Applicant: Precisely Software Incorporated, Burlington, MA (US)

(72) Inventors: Harsimran Singh Dhami, Zirakpur (IN); Harminder Singh, Zirakpur (IN)

(21) Appl. No.: 18/216,873

(22) Filed: Jun. 30, 2023

(51) Int. Cl. G06Q 30/018

(52) U.S. Cl. CPC G06Q 30/018

(57) ABSTRACT

A method for bulk data validation for draft-based SAP Fiori applications includes determining a uniform resource location (URL) of each of at least a draft business entity for a draft-based SAP Fiori application by identifying at least a location call for each of the at least a draft business entity in at least an OData batch call for the draft-based SAP Fiori application. Service metadata information is obtained from an SAP server and input parameters for each draft business entity are identified. Data type for each input parameter is determined using the service metadata information. The input parameters are sent to a user interface. The input parameters are updated with user input. The method further includes validating the updated input parameters for each of the at least a draft business entity by replaying the at least an OData batch call with the updated at least a location call.

### TECHNICAL FIELD

The subject matter described herein relates to bulk data validation. More particularly, the subject matter described herein relates to methods, systems, and computer readable media for bulk data validation for draft-based SAP Fiori applications.

### BACKGROUND

SAP provides Enterprise Resource Planning software catering to all business processes within an enterprise. Employees of an enterprise use SAP in their day-to-day business processes ranging from raw material purchase to production. Among various options available in SAP for entering business data is a JavaScript-based framework SAPUI5, which is used to create Fiori applications accessible from a web browser. Each Fiori application is a web application through which an enterprise can streamline their day-to-day business activities across different devices like computers, tablets, mobiles, etc. An SAP Fiori application interacts with SAP background servers via open data protocol (OData) batch requests. OData is an OASIS standard that defines a set of best practices for building and consuming RESTful Application Programming Interfaces (APIs). OData enables the creation of REST-based data services, which allow resources, identified using Uniform Resource Identifiers (URIs) and defined in a data model, to be published and edited by Web clients using simple Hypertext Transfer Protocol (HTTP) messages. Through Fiori applications, users can perform various business operations. A popular type of Fiori application, referred to herein as a draft-based SAP Fiori application, implements a draft concept that supports a stateless communication for storing on an SAP server temporary drafts of a business entity being created.

Most of the draft-based Fiori applications provide the option to end users for uploading to an SAP server a single business entity, such as a single business partner, single material, and the like. While working on a draft-based Fiori application, the user must upload each business entity separately and wait for confirmation that the business entity has successfully be uploaded. The Fiori application saves the business entity as an active entity in an SAP server after confirming that the data is valid. If the business entity is not successfully uploaded, the user will receive a validation error. A user is unable to cancel an upload of a business entity if there is no validation error. Uploading business entities separately and waiting for confirmation after each upload creates delays and increased effort for businesses to upload data to SAP.

### SUMMARY

The subject matter described herein includes methods, systems, and computer readable media for bulk data validation for draft-based SAP Fiori applications. A method for bulk data validation for draft-based SAP Fiori applications including determining a uniform resource location (URL) of each of at least a draft business entity for a draft-based SAP Fiori application by identifying at least a location call for each of the at least a draft business entity in at least an OData batch call for the draft-based SAP Fiori application. The method further includes obtaining service metadata information for the draft-based SAP Fiori application from an SAP server. The method further includes identifying at least an input parameter in the at least a location call for each of the at least a draft business entity. The method further includes determining a data type for each of the at least an input parameter using the service metadata information. The method further includes sending the at least an input parameter for each of the at least a draft business entity to a user interface. The method further includes receiving user input for the at least an input parameter from the user interface and updating the at least an input parameter in the corresponding at least a location call based on the user input. The method further includes validating the updated at least an input parameter for each of the at least a draft business entity by replaying the at least an OData batch call with the updated at least a location call. The method further includes receiving results of the validation from the SAP server and sending the results of the validation to the user interface.

A system for bulk data validation for draft-based SAP Fiori applications includes a processor, a memory communicatively connected to the processor, and computing device implemented using the processor and the memory. The computing device is configured for determining a uniform resource location (URL) of each of at least a draft business entity for a draft-based SAP Fiori application by identifying at least a location call for each of the at least a draft business entity in at least an OData batch call for the draft-based SAP Fiori application. The computing device is further configured for receiving, from each of the at least a subscriber subscribed to the first message, an acknowledgment that an action related to the first message is complete. The computing device is further configured for notifying the publisher that all acknowledgments related to the first message are received when the broker receives the acknowledgment from each of the at least a subscriber subscribed to the first message. The computing device is further configured for receiving, from the publisher, a second message based on the notification that all acknowledgments for the first message are received. The computing device is further configured for obtaining service metadata information for the draft-based SAP Fiori application from an SAP server. The computing device is further configured for identifying at least an input parameter in the at least a location call for each of the at least a draft business entity. The computing device is further configured for determining a data type for each of the at least an input parameter using the service metadata information. The computing device is further configured for sending the at least an input parameter for each of the at least a draft business entity to a user interface. The computing device is further configured for receiving user input for the at least an input parameter from the user interface and updating the at least an input parameter in the corresponding at least a location call based on the user input. The computing device is further configured for validating the updated at least an input parameter for each of the at least a draft business entity by replaying the at least an OData batch call with the updated at least a location call. The computing device is further configured for receiving results of the validation from the SAP server and sending the results of the validation to the user interface

The subject matter described herein may be implemented in or with software in combination with hardware and/or firmware. For example, the subject matter described herein may be implemented in or with software executed by a processor. In one example implementation, the subject matter described herein may be implemented using a computer readable medium having stored thereon computer executable instructions that when executed by the processor of a computer control the computer to perform steps. Example computer readable media suitable for implementing the subject matter described herein include non-transitory devices, such as disk memory devices, chip memory devices, programmable logic devices, and application-specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Embodiments of the subject matter described herein will now be explained with reference to the accompanying drawings, wherein like reference numerals represent like parts, of which:

FIG. 1 is a block diagram of an example system for bulk data validation for draft-based SAP Fiori applications according to an embodiment of the presently disclosed subject matter;

FIG. 2 shown an example payload of an inner HTTP call; and

FIG. 3 is a block diagram of an example method for bulk data validation for draft-based SAP Fiori applications according to an embodiment of the presently disclosed subject matter.

### DETAILED DESCRIPTION

The subject matter described herein includes methods, systems, and computer readable media for bulk data validation for draft-based SAP Fiori applications. A computing device may capture network traffic generated by a user interacting with a SAP background server via a web browser to create or edit a business entity. The computing device may scan the network traffic to identify OData batch calls among the traffic that is necessary for creating a draft business entity, such as location calls that identify a uniform resource locator (URL) of a created draft business entity, corresponding child calls and parent metadata calls. The computing device may download a service metadata document from the SAP server to find and interpret information within the OData batch calls. The computing device may identify input parameters for user input and, using the service metadata document, determine a data type for each of the input parameters. The computing device may send the input parameters and data types to a user interface and collect the corresponding user input for validation. The computing device may update the input parameters with the received user input and the OData batch calls, excluding an activation call that would active the draft business entity. The computing device may collect user input and update OData batch calls for a plurality of draft business entities for bulk validation.

When a user performs an end-to-end business operation on an application created using the SAPUI5 framework, such as a draft-based SAP Fiori application, multiple network calls interact with the background server. The network calls include OData batch calls interacting with business objects of SAP, JavaScript/CSS calls for the HTML page, authentication calls, etc. An open data protocol (OData) batch call is represented as a multipart Multipurpose Internet Mail Extensions (MIME) v1.0 message, a standard format allowing the representation of multiple parts, each of which may have a different content type. Instead of sending different HTTP OData calls, a single HTTP OData batch call is sent which wraps the different requests, or calls, which saves network overhead and improves performance. The single OData batch call is essentially an HTTP POST request to the $batch endpoint of a service. When a user starts creating a new business entity or edits an existing one, a draft is created in parallel in the background. If all mandatory fields have been filled and the business entity has a consistent state independently and also within its business environment and business processes, users can incorporate the edits into an active business entity. An OData batch call may include multiple inner HTTP calls.

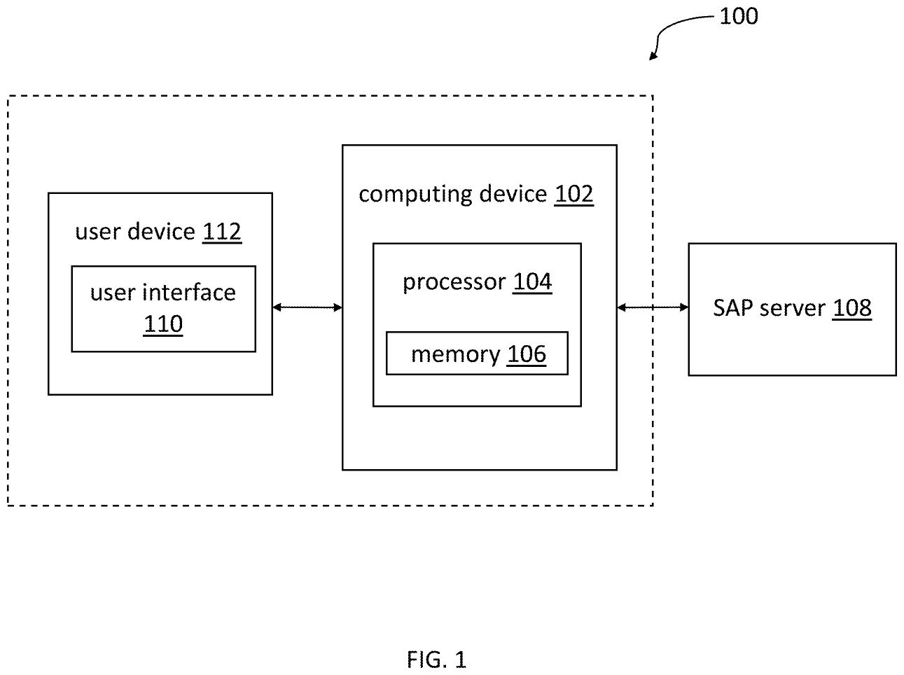

FIG. 1 is a block diagram illustrating an example system 100 for bulk data validation for draft-based SAP Fiori applications. A draft-based SAP Fiori application is also referred to herein as a Fiori application. System 100 may include a computing device 102 with at least one processor 104 and memory 106. A computing device may include, without limitation, a microcontroller, microprocessor, digital signal processor (DSP) and/or system on a chip (SoC) as described herein. A computing device may include, be included in, and/or communicate with a mobile device such as a mobile telephone or smartphone. A computing device may include a single computing device operating independently, or may include two or more computing device operating in concert, in parallel, sequentially or the like; two or more computing devices may be included together in a single computing device or in two or more computing devices.

Computing device 102 may be configured for analyzing network traffic generated between a web browser and a backend server, such as SAP server 108, when a user performs an end-to-end business operation on a draft-based SAP Fiori application via the web browser. SAP server 108 may include one or more servers in one or more locations. Computing device 102 may intercept network traffic from a draft-based SAP Fiori application on the world wide web. It is understood that computing device 102 may capture network traffic by other means such as tracing activity into a log from a draft-based SAP Fiori application on the web, mobile device, or other device. The network traffic may include OData batch calls interacting with business objects of SAP, JavaScript/CSS calls for the HTML page, authentication calls, and the like. Computing device 102 may identify and capture among the network traffic OData batch calls interacting with business objects of SAP that, if replayed, would perform the same business operation on the draft-based SAP Fiori application without a web browser as was performed by the user on the web browser. Each draft-based SAP Fiori application may use different OData batch calls.

Computing device 102 may further filter OData batch calls interacting with business objects of SAP from the rest of the OData batch calls. A draft is the first entity created in the background when a user begins working on a draft-based SAP Fiori application. SAP server 108 returns the Uniform Resource Identifier (URI) of the draft in a response header named “location” in one of the OData batch calls, referred to herein as a location call. The filter IsActiveEntity is set to false in this URI. Computing device 102 may identify at least a location call in OData batch calls based on the name of the response header “location” in the location call. Computing device 102 may also identify at least a location call by identifying that the filter IsActiveEntity in the URI of the call is set to false, such as in this example draft URI: https://www.company.com/MarkAttendence(EmpId=‘1064’,EmpCountry=‘IN’, IsActiveEntity=false).

Each draft call identified by Computing device 102 has multiple Child calls present in network traffic that are using corresponding draft. To identify a child call, computing device 102 may scan and compare the URI of each inner HTTP call of each OData batch call sent after the identified location call to the URI of the location call. Computing device 102 may identify a child call based on determining that one or more parameter names and corresponding parameter values in the URI of an inner HTTP call match one or more parameters in the URI of the location call. URIs may include a ResourcePath component identifying the resource with which to interact, such as customers, a single customer, orders related to customers in London, and so forth. The ResourcePath component may include one or more parameters to locate the draft. Further, in more complex SAP applications, each Child call itself may be a draft and hence will have more dependent child calls. Computing device 102 may be configured to determine that an inner HTTP call with one or more matching parameters is not essential for uploading business entities on a non-web browser interface, such as a call used only for improving user experience. A nonlimiting example of a call that computing device 102 may determine as nonessential and discard is an inner HTTP call including an HTTP verb GET.

In the example draft URI of an identified location call, https://www.company.com/MarkAttendence(EmpId=‘1064’,EmpCountry=‘IN’, IsActiveEntity=false), EmpId and EmpCountry are two parameters which are being used to identify an employee quickly. IsActiveEntity=false signifies that this business entity is a draft. Computing device 102 may scan subsequent OData batch calls where one of the inner HTTP call has URI: https://www.company.com/MarkAttendenceDay(EmpId=‘1064’,EmpName=‘J ohn’). In this URI, there is a parameter named EmpId. This parameter has the same name and value as in the draft URI of the location call mentioned above. Computing device 102 may then identify this inner HTTP call as a child call of the above location call.

Computing device 102 may identify at least a parent metadata call for each location call. Computing device 102 may identify the at least a parent metadata call based on matching metadata sent in request of the location call and metadata received as a response in the parent metadata call. Computing device 102 may identify metadata in the location call and scan OData batch calls made prior to the location call, identifying the at least a parent metadata call with metadata in response to matching the requested metadata in the location call. Each HTTP inner call in every OData network call may have a call body. The call body may contain data entered by the user and metadata information about the field in which the user entered data. For example, a sample call body in JSON format may include:

{
“EmpCity”:”Chandigarh”,
“_{——}metadata”:{
“uri”:”https://www.company.com/MarkAttendenceDay(EmpId=’1064’,EmpNa
me=’John’)”,
“type”:”Company.Engineer”
}
}

In this example call body, Chandigarh may be entered by a user while _metadata may be information used by a backend server, such as SAP server 108, and not visible to the user. An example response body to some other call previously made before location call may include:

{
d:{
“EmpCity”:””,
“_{——}metadata”:{
“uri”:”https://www.company.com/MarkAttendenceDay(EmpId=’1064’,EmpNa
me=’John’)”,
“type”:”Company.Engineer”
}
},
e:
[
{“Name”:”Jake”, “Age”:35, “State”, “Punjab”},
{“Name”:”John”, “Age”:34, “City”, “Haryana”}
]
}

Computing device 102 may recognize the metadata in the response body of a call made before location call matches the metadata in the location call request body and, therefore, identify the HTTP inner call containing the metadata response as a parent metadata call. Computing device 102 may also identify at least a parent metadata call for each child call by identifying metadata in the request body of child call and finding matching metadata among the response body of OData batch calls made prior to the child call. Computing device may discard OData batch calls other than location calls, child calls, and parent metadata calls.

Computing device 102 may obtain service metadata information for the Fiori application, such as a service metadata document. A service metadata document describes the data model, including the structure and organization of the resources, exposed as HTTP endpoints by the service. A service metadata document describes its data in entity data model (EDM) terms using an XML language for describing models called the Conceptual Schema Definition Language (CSDL). When exposed by an OData service as a service metadata document, the CSDL document is packed using an EDMX file format. Service metadata information may include information about type of data (string, integer, date, etc.) and other properties of each field used in an OData service call and response. Computing device 102 may download service metadata using an OData batch call URL. Computing device 102 may construct a URL to the service metadata document using an OData batch call URL identified among network traffic. For example, an OData batch call may include <http protocol>://<domainname>/<servicename>/$batch?<query parameters>. Computing device 102 may determine the service metadata document URL by replacing “$batch” and all subsequent text in the OData batch call URL with “$metadata.” Computing device 102 may use the service metadata URL to obtain the service metadata document. Any HTTP client may execute the URL to obtain the document.

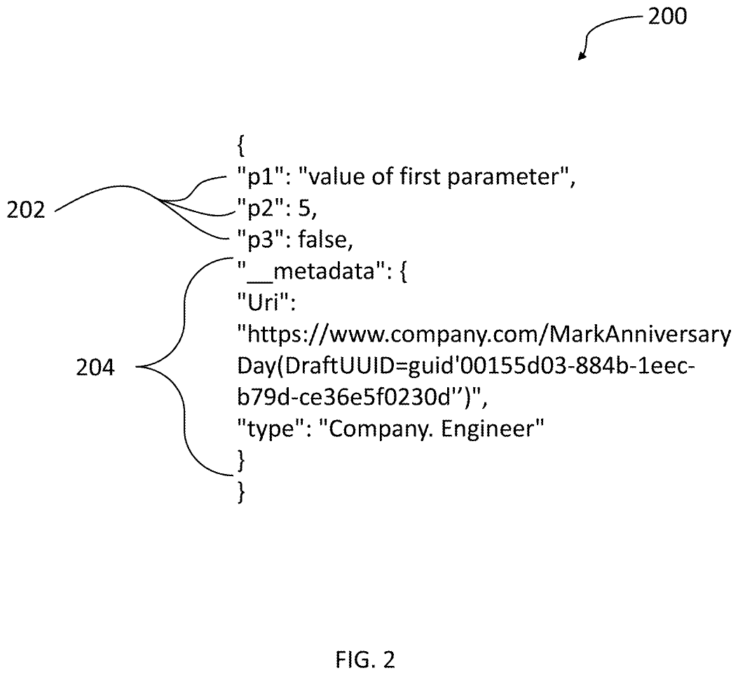

Using the service metadata information, computing device 102 may identify one or more input parameters in the location call. As used in this disclosure, an input parameter is any parameter excluding metadata parameters. Input parameters are parameters that a user may enter such as information a user inputs when creating a business entity. An OData batch call contains multiple inner HTTP calls. Each HTTP call's payload for a draft-based SAP Fiori application has a JSON body. FIG. 2 shows an example payload 200 of an inner HTTP call. This example JSON body includes four parameters, namely input parameters 202 p1, p2, and p3, and a metadata parameter 204. Computing device 102 may identify all parameters in at least an HTTP call payload within an OData batch call and may distinguish input parameters 202 from metadata parameter 204. The service metadata information may identify the data type for each of input parameters 202. Computing device 102 may determine a data type for each of input parameters 202 using the service metadata information. A data type defines the type of value a parameter may receive, such as “String,” “DateTime,” “Decimal,” and the like. The service metadata information may identify input parameters by name and list the corresponding data types for each of input parameters 202. After identifying at least one of input parameters 202 in one or more HTTP calls, computing device 102 may find the at least one of input parameters 202 in the service metadata document and identify the corresponding data types for each of the input parameters 202. Metadata parameter 204 in HTTP call payload 200 may include a property named “type,” which computing device 102 may use to find in the service metadata document input parameters 202 identified in payload 200. Each “type” may be grouped under an “EntityType” element in the service metadata document, for example:

<EntityType Name=“Engineer” sap:label=“Engineer in company” sap:content-
version=“1”>
<Property Name=“P1” Type=“Edm.String” Nullable=“true” MaxLength=“14”
sap:display-format=“UpperCase” sap:label=“First Parameter”/>
<Property Name=“P2” Type=“Edm.Int32” sap:label=“Second Parameter”/>
<Property Name=“P3” Type=“Edm.Boolean” sap:label=“Third Parameter”/>
<Property Name=“P4” Type=“Edm.Decimal” sap:label=“Fourth Parameter”/>
<Property Name=“P5” Type=“Edm.DateTime” sap:label=“Fifth Parameter”/>
<Property Name=“P6” Type=“Edm.String” sap:label=“Sixth Parameter”/>
</EntityType>.

The above HTTP call payload example includes input parameters p1, p2, and p3 for “type” Company.Engineer. Using the last string “Engineer,” computing device 102 may search the service metadata document for an “EntityType” element with property “Name” having a value “Engineer,” under which is listed the input parameters p1, p2, and p3 and their data types.

Computing device 102 may send identified input parameters 202 to a user interface 110, shown in FIG. 1, for a user to enter input for the input parameters 202. User interface 110 may include a third-party spreadsheet such as Microsoft® Excel®, SCV file, Google® Spreadsheet, HTML Page, databases, Airtable®, or any end user interface configured to receive input from a user. In some embodiments, computing device 102 may send and expose the data type to user interface 110 for each of corresponding input parameters 202, wherein each data type is displayed on the user interface 110 for a user to confirm that the user input entered is the appropriate data type. An example benefit to displaying on user interface 110 the data type for each of input parameters 202 is that the user can self-validate input to avoid improper input being rejected by the Fiori application. In some embodiments, computing device 102 may include user interface 110. Processor 104 may control the display and user input in the user interface 110. In other embodiments, as shown in FIG. 1, user interface 110 may be included in a user device 112 separate from computing device 102. User device 112 may be a computing device similar to computing device 102 and may include a processor similar to processor 104.

Computing device 102 may interface or communicate with one or more additional devices, such as SAP server 108 and/or user device 112 via a network interface device. Network interface device may be utilized for connecting computing device 102 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Computing device 102 may include but is not limited to, for example, a computing device or cluster of computing devices in a first location and a second computing device or cluster of computing devices in a second location. Computing device 102 may include one or more computing devices dedicated to data storage, security, distribution of traffic for load balancing, and the like. Computing device 102 may distribute one or more computing tasks as described below across a plurality of computing devices of computing device, which may operate in parallel, in series, redundantly, or in any other manner used for distribution of tasks or memory between computing devices.

Computing device 102 may receive user input for input parameters 202 from user interface 110 and update the input parameters 202 in the at least a location call, corresponding child calls and parent metadata call based on the user input. In some embodiments, computing device 102 may verify whether the received user inputs comply with the data types for the corresponding input parameters 202.

Computing device 102 may replay OData batch calls with the updated input parameters 202 to validate the OData batch calls, including the input parameters updated with the received user input, and confirm that the OData batch calls will not be rejected when sent to the Fiori application. Computing device 102 may replay the OData batch calls without activating the drafts. When a draft is activated, the SAP server 108 converts the draft business entity to an active business entity in the Fiori application. A draft may be activated by an activation call, which is an inner HTTP call that calls the activation action. To avoid activation while validating the OData calls, computing device 102 may identify and remove any activation calls among inner HTTP calls of the OData batch calls that would otherwise each activate a draft business entity if replayed. Computing device 102 may identify an activation call using a uniform resource locator (URL), such as a relative URL, and the service metadata information, such as the service metadata document. A relative URL format of an inner HTTP call may be <URLAction>?<URL parameters>. An example of a relative URL is: CompanyEmployeeActivation?EmpId=”,DraftUUID=guid‘00155d03-884b-1eec-b79d-ce36e5f0230d’.

The service metadata document includes FunctionImport elements. An example of a FunctionImport element is:

<FunctionImport Name=“CompanyEmployeeActivation”
ReturnType=“Company.Employee” EntitySet=“Emp”
m:HttpMethod=“POST” sap:action-for=“Company.EmployeeType”
sap:applicable-path=“Activation_ac”>
<Parameter Name=“P1” Type=“Edm.String” Mode=“In” MaxLength=“8”/>
<Parameter Name=“P2” Type=“Edm.String” Mode=“In” MaxLength=“1”/>
</FunctionImport>.

This sample FunctionImport element has a property “Name”, which is the same as the <URLAction> in the relative URL of each inner HTTP call inside the OData batch call. Computing device 102 may scan the FunctionImport elements in the service metadata document corresponding to each <URLAction> in the relative URL of inner HTTP calls and find the HTTP call for which the corresponding FunctionImport element has “applicable-path” property set to “Activation_ac”. This HTTP call is the activation call which will convert the draft into an active business entity in the Fiori application. Computing device 102 may exclude the activation call when replaying the OData batch calls for validation.

Draft-related parameters in the URL of inner HTTP calls and the property “_metadata” in the payload of inner HTTP calls change for each instance of a draft created by a draft-based SAP Fiori application and require updating. Computing device 102 may update draft-related parameters in the URL of inner HTTP calls while replaying the OData batch calls. In the above example relative URL is a draft-related parameter “DraftUUID” with a value that is a globally unique identifier (GUID). The GUID changes for each instance of a draft created. Draft-related parameters, such as DraftUUID, need to be dynamically updated to match already updated draft-related parameters in replayed OData batch calls. Computing device 102 may update the draft-related parameters in the URL based on updated values of the same parameters in location calls that have already been replayed. The header in a location call is the URL of the draft and includes one or more parameters. An example URL of a draft in a location header is: <http protocol>://<domainname>/<servicename>/<service method endpoint>?A=B&C=D.

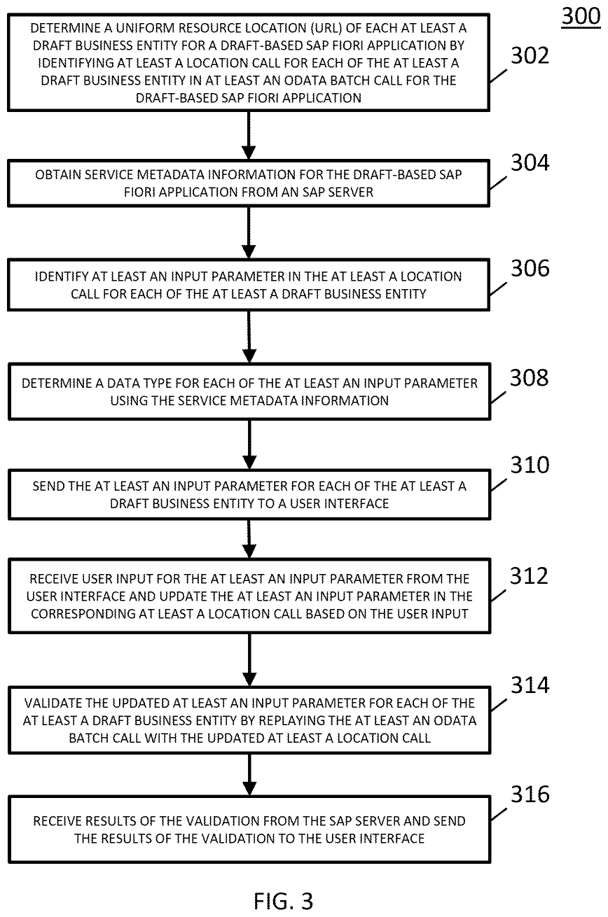

This URL of the draft includes parameters “A” and “C” with values “B” and “D,” respectively. A location call that has been replayed contains in response a location header updated values of draft-related parameters. When replaying an OData batch call, computing device 102 may scan location calls that have already been replayed to find the same parameter name with the corresponding updated parameter value. Computing device 102 may update the draft-related parameters in the URL of an inner HTTP call with the updated parameter values of the same parameter names in the replayed location call. In some embodiments, there may be multiple drafts created with the same draft-parameter names but different values in each draft. Computing device 102 may, upon finding multiple drafts with inconsistent draft-parameter values, track the exact location call by scanning already recorded data. In the recorded data, computing device 102 can track which location call is returning the exact parameter name and value which is part of a particular HTTP call within the same dataset. For example, there can be an OData call that is traced in network traffic in step 302 of FIG. 3 with the following parameter-value combination in URI: A=B&C=D, which represents parameter names A and C with values B and D, respectively. If there are 2 location calls identified in step 302 of FIG. 3, with a first location call having a draft in location header with the following parameter-value in URI: A=BB&C=DD, while a second location call has a draft in location header with following parameter-value in URI: A=B&C=D. In this example, both drafts have same parameter name A & C, but the values of the second draft exactly matches the values present in the OData call being traced, so the OData call would update its parameters using the second location call, not the first.

Computing device 102 may update the metadata parameter in the payload of the inner HTTP calls, specifically the URI in the metadata parameter. The metadata parameter may include a dynamic property “URI” that changes for each instance of a draft created by a draft-based SAP Fiori application. The metadata parameter may also include a property “type” that is constant. Referring again to FIG. 2, metadata parameter 204 in payload 200 includes property “type” with a constant string of “Company. Engineer”.

Computing device 102 may scan responses of OData calls executed before the current HTTP call to which payload 200 is in for a response containing a property “type” matching that of the property “type” in metadata parameter 204, namely ““Company. Engineer”. Computing device 102 may update the property “URI” value in metadata parameter 204 to match the value of property “URI” in this response payload. If computing device 102 identifies multiple metadata parameters in response payloads with a property “type” value matching the property “type” value in metadata parameter 204, the computing device 102 may update the property “type” value in the metadata parameter 204 with the property “type” value in the most recent response payload.

Computing device 102 may validate the updated OData batch calls by replaying the at least a location call, the at least a corresponding child call, and/or the at least a parent metadata call with updated input parameters 202, URL, and metadata parameter 204 with a preparation call, while excluding any activation calls. Validating entity being created in SAP may include executing a preparation call and reviewing a response to the preparation call. A preparation call is an inner HTTP call that calls a preparation action, as defined by SAP. When SAP server 108 receives a preparation call, the SAP server 108 performs one or more consistency checks on the entity being created and returns a message confirming whether the preparation action was successful. In the response, SAP server 108 may identify errors in the OData batch calls if the preparation action was unsuccessful, for example with an error code.

Computing device 102 may identify a preparation call with a method similar to identifying an activation call as described herein. An example relative URL for a preparation call is: CompanyEmployeePreparation?EmpId=”,DraftUUID=guid‘00155d03-884b-1eec-b79d-ce36e5f0230d’. An example of a FunctionImport element is:

<FunctionImport Name=“CompanyEmployeePreparation”
ReturnType=“Company.Employee” EntitySet=“Emp” m:HttpMethod=“POST”
sap:action-for=“Company.EmployeeType” sap:applicable-
path=“Preparation_ac”>
<Parameter Name=“P1” Type=“Edm.String” Mode=“In” MaxLength=“8”/>
<Parameter Name=“P2” Type=“Edm.String” Mode=“In” MaxLength=“1”/>
</FunctionImport>.

This sample FunctionImport element has a property “Name”, which is the same as the <URLAction> in the relative URL of each inner HTTP call inside the OData batch call. To find the preparation call, computing device 102 may scan the FunctionImport elements in the service metadata document corresponding to each <URLAction> in the relative URL of inner HTTP calls and find the HTTP call for which the corresponding FunctionImport element has “applicable-path” property set to “Preparation_ac”. If computing device 102 receives an error code from SAP server 108 in response to preparation call, computing device 102 may scan the response body and identify all the string values of property “message” under the parent property “error”. For example, for the example response body {“error”:{“message”: “Employee ID cannot be empty”}}, computing device 102 may send to user interface 110 a portion of the response to the preparation call, such as the string value “Employee ID cannot be empty” in this example response.

It is understood that the method described may be for a plurality of draft business entities. For example, computing device 102 may identify location calls, child calls, and parent metadata calls for each of a plurality of draft business entities. Computing device 102 may determine, using the service metadata document, the data type for each at least an input parameter for each draft business entity, send the input parameters to user interface 110, and receive from the user interface 110 user input for the input parameters. Computing device 102 may identify and remove any activation calls for the draft business entities, update draft-related parameters and metadata parameters 204 for each draft business entity, and replay the updated OData batch calls for validation. Computing device 102 may include a preparation call for each draft business entity during validation.

In some embodiments, computing device 102 may be configured for activating the one or more draft business entities if the computing device 102 receives a success code from SAP server 108 in response to the validation, such as a preparation call for the respective business entities. Activating the at least a draft business entity may include replaying the activation call previously identified.

FIG. 3 is a block diagram of example method 300 for bulk data validation for draft-based SAP Fiori applications. In some embodiments, method 300, or portions thereof, may be performed by or at computing device 102. In step 302, the computing device determines a uniform resource location (URL) of each at least a draft business entity for a draft-based SAP Fiori application by identifying at least a location call for each of the at least a draft business entity in at least an OData batch call for the draft-based SAP Fiori application. The at least a draft business entity may include a plurality of draft business entities for bulk validation of multiple draft business entities. The computing device may filter at least an OData batch call among network traffic for an SAP Fiori application and identify at least a location call for each of the at least a draft business entity in the at least an OData batch call. The computing device may identify at least a corresponding child call and at least a parent metadata call.

In step 304, the computing device obtains service metadata information for the draft-based SAP Fiori application from an SAP server.

In step 306, the computing device identifies at least an input parameter in the at least a location call, corresponding child call and parent metadata call for each of the at least a draft business entity.

In step 308, the computing device determines a data type for each of the at least an input parameter using the service metadata information.

In step 310, the computing device sends the at least an input parameter for each of the at least a draft business entity to a user interface. The computing device may display on the user interface the determined data type for each of the at least an input parameter.

In step 312, the computing device receives user input for the at least an input parameter from the user interface and updates the at least an input parameter in the corresponding at least a corresponding location call/child call/parent metadata call based on the user input.

In step 314, the computing device validates the updated at least an input parameter for each of the at least a draft business entity by replaying the at least an OData batch call with the updated at least a location call/child call/parent metadata call. The computing device may identify an activation call among the at least an OData batch call using the service metadata information and exclude playing the activation call during the validation. The computing device may send a preparation call to the SAP server. The computing device may update a metadata parameter in the at least an OData batch call based on a response received from the SAP server for a previous OData batch call.

In step 316, the computing device receives results of the validation from the SAP server and sends the results of the validation to the user interface. In some embodiments, method 300 may further include activation of the at least a draft business entity by replaying the activation call previously identified.

It will be appreciated that method 300 is for illustrative purposes and that different and/or additional actions may be used. It will also be appreciated that various actions described herein may occur in a different order or sequence.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for bulk data validation for draft-based SAP Fiori applications, the method comprising:
determining a uniform resource location (URL) of each of at least a draft business entity for a draft-based SAP Fiori application by identifying at least a location call for each of the at least a draft business entity in at least an OData batch call for the draft-based SAP Fiori application;
obtaining service metadata information for the draft-based SAP Fiori application from an SAP server;
identifying at least an input parameter in the at least a location call for each of the at least a draft business entity;
determining a data type for each of the at least an input parameter using the service metadata information;
sending the at least an input parameter for each of the at least a draft business entity to a user interface;
receiving user input for the at least an input parameter from the user interface and updating the at least an input parameter in the corresponding at least a location call based on the user input;
validating the updated at least an input parameter for each of the at least a draft business entity by replaying the at least an OData batch call with the updated at least a location call; and
receiving results of the validation from the SAP server and sending the results of the validation to the user interface.

2. The method of claim 1, wherein the at least a draft business entity comprises a plurality of draft business entities.

3. The method of claim 1, wherein identifying at least a location call for each of the at least a draft business entity in at least an OData batch call for an SAP Fiori application comprises:
filtering at least an OData batch call among network traffic for an SAP Fiori application; and
identifying at least a location call for each of the at least a draft business entity in the at least an OData batch call.

4. The method of claim 3 comprising identifying at least a child call and at least a parent metadata call.

5. The method of claim 1 wherein validating the updated at least an input parameter updated with the user input for each of the at least a draft business entity comprises:
identifying an activation call among the at least an OData batch call using the service metadata information; and
replaying the at least an OData batch call excluding the activation call.

6. The method of claim 1 wherein validating the updated at least an input parameter updated with the user input for each of the at least a draft business entity comprises sending a preparation call to the SAP server.

7. The method of claim 6 further comprising updating a metadata parameter in the at least an OData batch call based on a response received from the SAP server.

8. The method of claim 1, wherein sending the at least an input parameter to a user interface comprises displaying on the user interface the determined data type for each of the at least an input parameter.

9. A system for bulk data validation for draft-based SAP Fiori applications, the system comprising:
a processor;
a memory communicatively connected to the processor; and
a computing device implemented using the processor and the memory, wherein the computing device is configured for:
determining a uniform resource location (URL) of each of at least a draft business entity for a draft-based SAP Fiori application by identifying at least a location call for each of the at least a draft business entity in at least an OData batch call for the draft-based SAP Fiori application;
obtaining service metadata information for the draft-based SAP Fiori application from an SAP server;
identifying at least an input parameter in the at least a location call for each of the at least a draft business entity;
determining a data type for each of the at least an input parameter using the service metadata information;
sending the at least an input parameter for each of the at least a draft business entity to a user interface;
receiving user input for the at least an input parameter from the user interface and updating the at least an input parameter in the corresponding at least a location call based on the user input;
validating the updated at least an input parameter for each of the at least a draft business entity by replaying the at least an OData batch call with the updated at least a location call; and
receiving results of the validation from the SAP server and sending the results of the validation to the user interface.

10. The system of claim 9, wherein the at least a draft business entity comprises a plurality of draft business entities.

11. The system of claim 9, wherein identifying at least a location call for each of the at least a draft business entity in at least an OData batch call for an SAP Fiori application comprises:
filtering at least an OData batch call among network traffic for an SAP Fiori application; and
identifying at least a location call for each of the at least a draft business entity in the at least an OData batch call.

12. The system of claim 11 wherein the computing device is configured for identifying at least a child call and at least a parent metadata call.

13. The system of claim 9 wherein validating the updated at least an input parameter updated with the user input for each of the at least a draft business entity comprises:
identifying an activation call among the at least an OData batch call using the service metadata information; and
replaying the at least an OData batch call excluding the activation call.

14. The system of claim 9 wherein validating the updated at least an input parameter updated with the user input for each of the at least a draft business entity comprises sending a preparation call to the SAP server.

15. The system of claim 14 wherein the computing device is configured for updating a metadata parameter in the at least an OData batch call based on a response received from the SAP server.

16. The system of claim 9, wherein sending the at least an input parameter to a user interface comprises displaying on the user interface the determined data type for each of the at least an input parameter.

17. A non-transitory computer readable medium having stored thereon executable instructions that when executed by at least one processor of at least one computer cause the at least one computer to perform steps comprising:
determining a uniform resource location (URL) of each of at least a draft business entity for a draft-based SAP Fiori application by identifying at least a location call for each of the at least a draft business entity in at least an OData batch call for the draft-based SAP Fiori application;
obtaining service metadata information for the draft-based SAP Fiori application from an SAP server;
identifying at least an input parameter in the at least a location call for each of the at least a draft business entity;
determining a data type for each of the at least an input parameter using the service metadata information;
sending the at least an input parameter for each of the at least a draft business entity to a user interface;
receiving user input for the at least an input parameter from the user interface and updating the at least an input parameter in the corresponding at least a location call based on the user input;
validating the updated at least an input parameter for each of the at least a draft business entity by replaying the at least an OData batch call with the updated at least a location call; and
receiving results of the validation from the SAP server and sending the results of the validation to the user interface.

18. The medium of claim 17, wherein the at least a draft business entity comprises a plurality of draft business entities.

19. The medium of claim 17 wherein validating the updated at least an input parameter updated with the user input for each of the at least a draft business entity comprises:
identifying an activation call among the at least an OData batch call using the service metadata information; and
replaying the at least an OData batch call excluding the activation call.

20. The medium of claim 19 wherein validating the updated at least an input parameter updated with the user input for each of the at least a draft business entity comprises sending a preparation call to the SAP server.
